(19) United States
(12) Patent Application Publication
(10) Pub. No.: US 2009/0300503 A1
(43) Pub. Date: Dec. 3, 2009

(54) METHOD AND SYSTEM FOR NETWORK-BASED AUGMENTATIVE COMMUNICATION

(75) Inventors: Karen Elaine Suhm, Phoenix, AZ (US); Faridodin Lajvardi, Gilbert, AZ (US); Martha Ann Baio, Chandler, AZ (US); Staci Lee Neustadt, Scottsdale, AZ (US)

Correspondence Address: INVENTIVITY, LLC, 2009 NORTH 7TH STREET, PHOENIX, AZ, 85006, US

(73) Assignee: ALEXICOM TECH, LLC, Phoenix, AZ (US)

(21) Appl. No.: 12/477,116

(22) Filed: Jun. 2, 2009

Related U.S. Application Data
(60) Provisional application No. 61/057,884, filed on Jun. 2, 2008.

(51) Int. Cl. G06F 15/16; G10L 13/08; G06F 17/00; G06F 3/00

(52) U.S. Cl. 715/733; 704/260; 700/94; 709/203

(57) ABSTRACT

The present invention discloses a method and system of augmentative communication which employs a server, a network, and a client device to generate augmentative communication output on the client device. A user on the client device receives augmentative communication output by generating a request directed to the server, which the server receives through the network. The server retrieves the requested augmentative communication content from storage and outputs it to the client device through the network. In one mode of operation, augmentative communication content is outputted directly from the server to one or more means for generating perceptible output on the client device. In a second mode of operation, the augmentative communication content is provided to the client device as a set of augmentative communication pages, whereby once the client device has received the set of pages, the connection to the server is no longer needed. Thus, the present invention provides the user with augmentative communication output that is portable, accessible from multiple devices, and requires little storage space or processing power from the user's device. A network-based method and system for creating and editing augmentative communication pages is also provided.

### CROSS-REFERENCE TO RELATED APPLICATIONS

This application claims the benefit of PPA Ser. No. 61/057,884 filed by the present inventors on Jun. 2, 2008.

### FEDERALLY SPONSORED RESEARCH

Not Applicable

### COPYRIGHT NOTIFICATION

Portions of this patent application contain materials that are subject to copyright protection. The copyright owner has no objection to the facsimile reproduction by anyone of the patent document, or the patent disclosure, as it appears in the Patent and Trademark Office, but otherwise reserves all copyright rights.

### REFERENCE TO COMPUTER PROGRAM LISTING APPENDIX

A computer program listing appendix is included herewith as Appendix A to this application. The computer program listing consists of one ASCII text file with filename AppendixA.txt, size 644,816 bytes, created on May 23, 2009, submitted electronically via the USPTO EFS-Web system. The computer program listing is subject to copyright protection and any use thereof, other than as part of the reproduction of the patent document or the patent disclosure, is strictly prohibited.

### BACKGROUND OF THE INVENTION

1. Field of Invention

The present invention relates generally to a system and method of augmentative communication and, in particular, to a system and method of network-based augmentative communication in which a server is used to generate augmentative communication output on a client device.

2. Prior Art

According to the American Speech and Hearing Association, there are two million people in the United States living with a communication disorder that impairs their ability to talk. These individuals, who may suffer from autism, stroke, Lou Gehrig's Disease, cerebral palsy, or other condition which limits their verbal communication skills, use augmentative and alternative communication (AAC) to help them communicate with others. They may use one or more AAC systems, which incorporate visual output, audio output, or both.

Augmentative communication systems have been around for decades in one form or another. One early example of this is the Bliss system, introduced in the 1930's by C. K. Bliss. This device was comprised of four hundred symbol cards with associated English words. Users located the cards representing what they wanted to communicate and showed them to others. Even today, word and picture communication sheets, boards, and notebooks are commercially available from Interactive Therapeutics, Inc. (Stow, Ohio). This AAC system is affordable, but can be cumbersome and requires patience on the part of both the user and the person to whom the user wishes to communicate.

Early electronic augmentative communication devices replaced symbol cards. These devices commonly featured touch pads with removable overlays. The overlays contained pictures and/or text covering pads which, when pressed by the user, caused the device to play back an associated recording stored in the device's memory. As the user's vocabulary grew, so did the number of overlays in the user's collection.

In recent decades, touch pads with removable overlays have widely been replaced by laptop-sized devices with touch screen digital displays and dynamically programmable matrices of images. In these devices, each image produces a particular speech output when pressed. Common elements of these devices include a microprocessor, memory, an integrated input and display unit, a speech engine, and at least one speaker. Several patents have been issued for such devices, including U.S. Pat. Nos. 4,558,315 (1985) to Weiss, et al., 5,047,953 (1991) and 5,113,481 (1992) to Smallwood, et al., 5,097,425 (1992) to Baker, et al., 5,956,667 (1999), 6,260,007 (2001), 6,266,631 (2001), and 6,289,301 (2001) to Higginbotham, et al., 6,903,723 (2005) to Forest, and 7,389,232 (2008) to Bedford, et al.

A number of augmentative communication devices are commercially available from Dynavox Systems, LLC (Pittsburgh, Pa.), Prentke Romich Company (Wooster, Ohio), and Zygo Industries, Inc. (Portland, Oreg.), among others. These devices typically cost between $7,000 and $15,000 and run proprietary AAC software on touch screen notebook computers. Despite the fact that many of these devices run Windows operating systems, the user is prohibited from installing additional applications. Thus, even if the user already has a computer, he must purchase another one to use as an AAC device. If the user has limited mobility and requires an assistive input device like a scanning mouse, a head pointer, or eye input device, the need for two computers can present an even larger problem.

An additional shortcoming of most commercially available augmentative communication devices is that they do not support direct downloading of images from the Internet or a computer connected through a local network. These devices come with a set of line drawings for use as images but some individuals have difficulty associating abstract representations of things with real-world things. These individuals often need photographs to make the connection between an image on an AAC device and the desired communication output. Other individuals simply wish to personalize their communication pages with pictures of family, friends, and familiar things. Most commercially available AAC devices allow new images to be added, but the image must first be transferred to a USB flash drive and then to the device, doubling the amount of work that must be performed to get the image to the desired location.

Another situation arises when a user's augmentative communication device stops functioning properly. Most commercially available devices are so specialized and inaccessible to the user that they must be returned to the manufacturer for repair. This typically means that the user will be left without a device, and hence without a voice, for four to six weeks until the device is returned in working order. When the user gets the device back, it may or may not contain the user's personalized content, including any images or communication pages that the user might have added.

Not to be forgotten are those individuals who only require an AAC device for a short period of time. Examples of such individuals include those who are recovering from vocal chord trauma, have suffered a slight stroke, or are intubated. These users are often unwilling or unable to invest $7,000 to $15,000 in a device that they will only use for a few weeks or months.

3. Advantages

As laptop and tablet computers continue to become smaller and faster, and as cell phones, portable music players, and personal digital assistants are becoming increasingly more cross-functional, these devices are well-suited for augmentative communication applications. An advantage of the present invention is that it is versatile across devices and requires little storage space or processing power on the user's portable device. The server does the majority of the work.

The present invention offers a low cost alternative to expensive devices and allows the user to access his or her communication pages across multiple devices that the user may already own. Any device with a standard web browser may be used. This aspect of the invention is appealing to short-term user and individuals with limited mobility who must rely on assistive input devices and already have a computer equipped with an assistive technology apparatus. This aspect of the present augmentative communication system also offers the advantage of making the user's communication pages available to the user from an alternate device should the user's primary device fail.

Another advantage of the present invention is that image uploads are easy and straightforward. Images may be saved directly from the Internet or the user's device. Real images selected by the user make communication easier, offering specific and understandable choices. The user is able to control the complexity and content of the user's communication pages. Text-based and image-based methods of communication are supported and the density and size of user controls may be adjusted to fit the user's device and skill level.

An additional advantage of the present invention is that it allows the user to access communication pages in an extended range of formats. Pages may be accessed through the Internet and may be published as a set of augmentative communication pages for offline use. Communication pages may be projected to an interactive whiteboard and shared in a chat group or classroom setting. Pages may easily be transferred from one device to another. Pages may even be printed out and laminated to make communication boards that go anywhere, including the bathtub or pool.

The present invention also offers the advantage of transparent software upgrades and other improvements. As new features and language support are added, they are automatically available to the user. As data transfer rates increase and programming languages become more sophisticated, the communicative capabilities of the present invention will continue to become more advanced. Still further advantages will become apparent from a consideration of the ensuing description and drawings.

### BRIEF SUMMARY OF THE INVENTION

In light of the foregoing objects, there is provided, according to the present invention, a method and related system of augmentative communication which utilizes a server, a network, and a client device to generate augmentative communication output on the client device in response to a user's input. Specifically, the present invention provides a method and system by which a user obtains augmentative communication content from a server through a network. This augmentative communication content is comprised of images, text, audio files, user controls in the form of computer-readable program code, or a combination thereof. The user controls, when activated by the user on the client device, generate perceptible augmentative communication output on the client device in the form of audio, visual, or audio-visual output on the client device. The content, style, and quantity of text, images, and user controls, as well as the augmentative communication outputs generated on the client device are user-programmable and editable so that the user, a caregiver, or therapist can adapt the system to meet the user's changing needs and abilities.

### BRIEF DESCRIPTION OF THE DRAWINGS

The various aspects and advantages of the present invention will become more apparent in connection with a detailed description and drawings as discussed below, wherein like reference numerals through the drawings represent like elements; wherein the preferred embodiments of the present application should not be considered limitative of the present application; and wherein:

FIG. 1A is a block diagram of the augmentative communication method and system in accordance with the present invention;

FIG. 1B is a detailed block diagram showing the components of the augmentative communication method and system of the present invention;

FIGS. 2A and 2B are event flowcharts illustrating the overall process of the present invention;

FIGS. 3-4 are flowcharts of one embodiment of the present invention in operation as an augmentative communication device;

FIG. 5A is a block diagram of the authoring functions of one embodiment of the present invention;

FIG. 5B is an illustration of the editing screen of an embodiment of the present invention; and

FIG. 5C is an illustration of the control cell editor of one embodiment of the present invention.

### DETAILED DESCRIPTION OF THE PREFERRED EMBODIMENTS

In the following description, the terms “server”, “database”, and “client” are used in a generic functional sense. The terms “server” and “client” are presented as defined within the client/server architectural model, where the client requests a service and the server provides a service. The term “database” is defined in its broadest sense, as a data structure for storing records. The server and database could reside on one computer or could, alternatively, be housed in different pieces of hardware using a distributed network system, where the functional elements of a server or database are distributed among nodes and are able to migrate from node to node. The server, database, and client are open to many variations in configuration, as is well known in the art.

The terms “network” and “client device” are also used in the most general sense. A “client device” is any computing means, from a single microprocessor to a computer system distributed over multiple processing nodes. A “network” is a series of nodes interconnected by communication paths and includes any means that connects computers. Other terms in the text are also to be understood in a generic functional sense, as would be known by one skilled in the art.

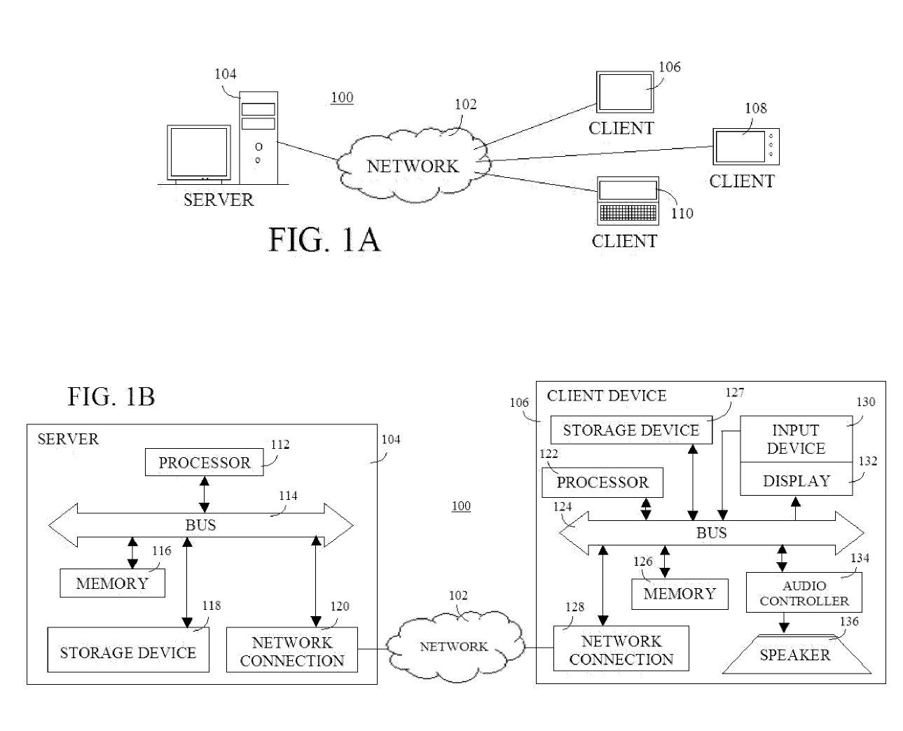

Referring now to FIG. 1A, a method and system for network-based augmentative communication is generally identified by the numeral 100. This system contains a network 102, which provides communications links between network nodes, such as switches, routers, computers, or other devices. Network 102 may include physical conduit, wire, wireless communication links, fiber optic cable, or any combination thereof. Network 102 is connected to a server 104 and one or more client devices 106, 108, and 110. Client devices 106, 108, and 110 represent unique clients, independent and unrelated to each other, where each may comprise, for example, a personal computer (PC), laptop computer, tablet PC, web-enabled cell phone, personal digital assistant (PDA), Bluetooth-enabled device, or other portable device with network access. Augmentative communication system 100 may include additional servers, client devices, and other devices not shown.

In the example of FIG. 1A, network 102 represents a global collection of networks and gateways, which use Transmission Control Protocol/Internet Protocol (TCP/IP) protocols to communicate with each other. In various embodiments, augmentative communication system 100 may be implemented using many different types of networks 102, such as an intranet, a Local Area Network (LAN), a Wide Area Network (WAN), a Personal Area Network (PAN) or a dial-up network. Named pipes may also be used in place of TCP/IP. FIG. 1A is provided as an example and is not intended to represent an architectural limitation for the present invention.

FIG. 1B represents a block diagram of the augmentative communication system 100 showing the components in greater detail. Server 104 includes at least one processor 112, and may include a plurality of processors, such as a symmetric multiprocessor (SMP). Connected to processor 112 is a bus 114, which is also connected to memory 116. Bus 114 is further connected to at least one storage device 118, such as an IDE or SATA hard drive or Redundant Array of Inexpensive Disks (RAID), and to network connection 120.

Network connection 120 may comprise a network adapter or modem. Bus 114 may, in actuality, consist of a plurality of buses, including, for example, a system bus, an input/output (I/O) bus, and one or more Peripheral Component Interconnect (PCI) buses. Bus 114 may also include connections to PCI expansion slots, through which more than one network connection 120 may be established.

Storage device 118 provides processor 112 with an operating system, server software, augmentative communication application software, and network address information. In one embodiment of the invention, the augmentative communication application software is a web site and storage device 118 contains one or more databases, a text-to-speech (TTS) engine, programming language support that preferably supports partial page refreshes, and a mail server. Additional storage devices may be connected through bus 114 to support storage device 118.

Client device 106 includes a processor 122, memory 126, storage device 127, and network connection 128, connected to each other by bus 124. Processor 122 may be an SMP or a single processor and bus 114 may consist of a plurality of buses, including, for example, a system bus, an I/O bus, an audio bus, and one or more PCI buses. In one embodiment of the invention, storage device 127 contains operating system software, web browser software, and web page content, which includes, but is not limited to, augmentative communication content received from server 104 via network 102.

Bus 124 on client device 106 is also connected to at least one input device 130 and display unit 132. In the first embodiment of the invention, input device 130 and display 132 are an integrated unit. Examples of integrated units include touch screens and interactive whiteboards. In accordance with the various embodiments of the present invention, alternative input devices 130 may be used in combination with or in place of integrated input device 130. Acceptable alternative input devices include a keyboard, a pointing device, one or more switches, a mouse, a mouse-compatible scanning or selecting device, or other volitional means used for selecting.

Client device 106 produces audio output via an audio controller 134 and speaker 136. Speaker 136 may include amplification circuitry so that its output is audible to persons other than the user. Audio player software is also contained in storage device 127. In one embodiment of the present invention, the audio player software supports streaming WAV, MP3, and SWF audio formats.

Those of ordinary skill in the art will appreciate that the hardware depicted in FIG. 1B may vary. For example, other means of generating perceptible output, other peripheral devices, external hard drives, or a combination thereof may be used in addition to or in place of the hardware depicted. The figure is not meant to imply architectural limitations with respect to the present invention.

A prototype system in accordance with the system depicted in FIG. 1B has been successfully constructed. In this prototype, the server is comprised of a Pentium Core 2 Duo processor operating at 2.4 GHz with 2 GB RAM on a Windows XP Professional operating system. This server runs Microsoft Internet Information Services (IIS) 5.1 as a web server and is connected to the Internet through a TCP/IP socket on a Broadcom NetXtreme 57XX Gigabit Ethernet Controller. The prototype server contains an AJAX-enabled ASP.NET 3.5 web site, included in Appendix A, which utilizes a Microsoft SQL Server 2005 database, Microsoft Speech Application Programming Interface (SAPI) 5.1, and Microsoft Sam, Mary, and Mike voices. Functionality of the prototype system has been confirmed using several client devices including desktop, laptop, and ultra-mini personal computers running Microsoft Windows 2000, Windows XP, and Vista operating systems and Microsoft Internet Explorer (IE) 6, IE7, Mozilla FireFox 3.0.4, Google Chrome 1.0.154.65, Apple Safari 3.2.1, and Opera 9.52 web browsers. The prototype embodiments have been shown to function in accordance with the present invention.

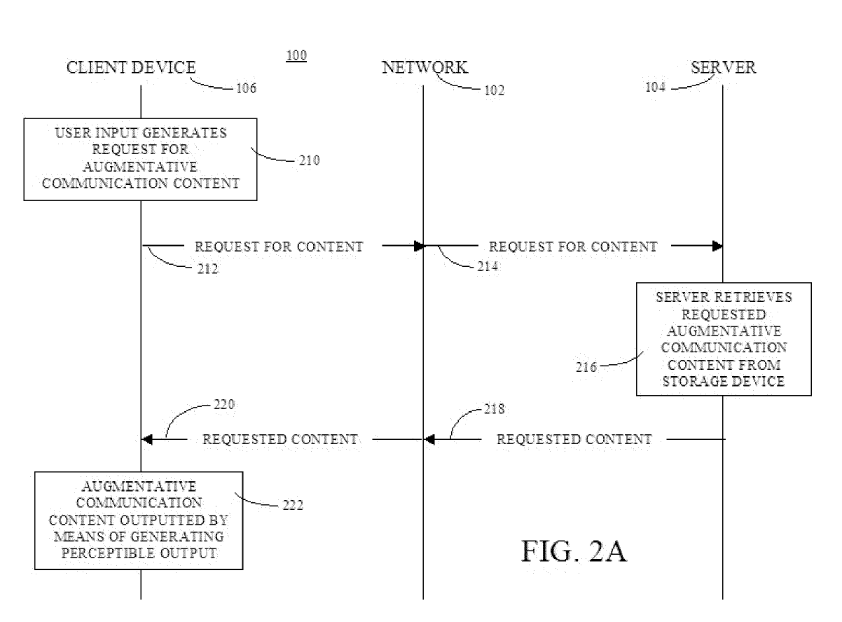

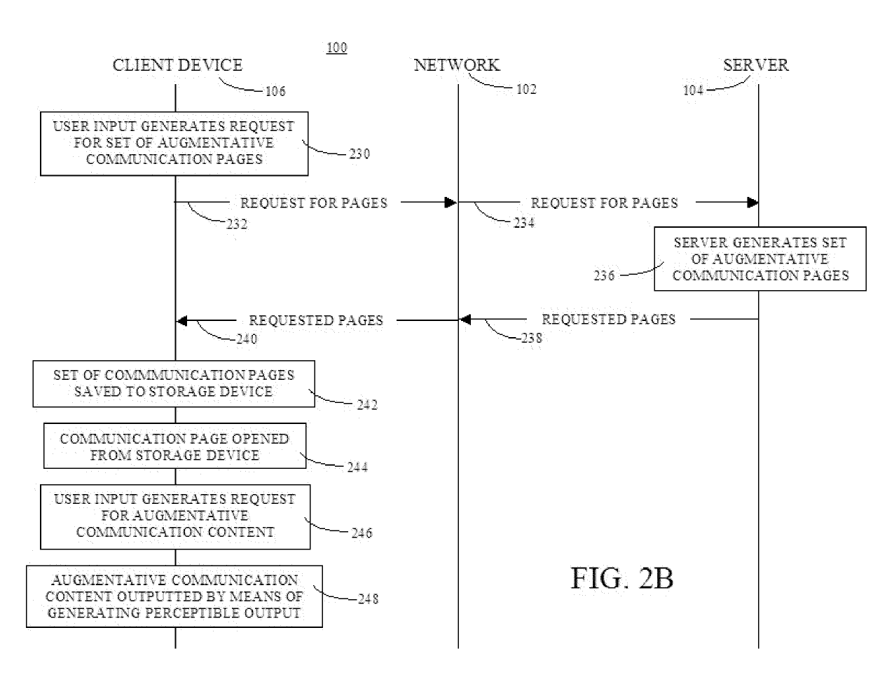

### Event Flow—FIGS. 2A-2B

FIG. 2 identifies a collection of sequenced events and illustrates how the various components of the present invention interact to generate augmentative communication output on client device 106. Referring first to FIG. 2A, the method and system of the present invention are generally identified by the numeral 100. Client device 106 is connected to server 104 via network 102.

In step 210, a user generates a request for augmentative communication content using input device 130 (not shown in FIG. 2A) connected to client device 106. This request travels from client device 106 to network 102 in step 212, and from network 102 to server 104 in step 214. Server 104 processes the request in step 216, retrieving the requested augmentative communication content from storage device 118 (not shown in FIG. 2A) connected to server 104.

The requested augmentative communication content is outputted by server 104 to network 102 in step 216. The content is received from network 102 by client device 106 in step 220. Client device 106 processes the augmentative communication content in step 222, generating perceptible output on speaker 136, display 132, other means for generating perceptible output on client device 106, or a combination thereof. The user may generate additional augmentative communication output on client device 106 by repeating steps 210 through 222.

The first embodiment of the present invention includes a second mode of operation, wherein augmentative output is generated on client device 106 via an alternate sequence of events. In this alternate flow, diagramed in FIG. 2B, the method and system of the present invention are identified by the numeral 100 and client device 106 is connected to server 104 via network 102.

The event flow of FIG. 2B begins in step 230, where the user generates a request for a set of augmentative communication pages using input device 130 (not shown) connected to client device 106. This request is transmitted from client device 106 to network 104 in step 232 and from network 102 to server 104 in step 234. In step 236, server 104 processes the request by retrieving content from storage device 118 (not shown in FIG. 2B) and generating the set of augmentative communication pages.

In step 238, server 104 outputs the requested set of augmentative communication pages to network 102. Client device 106 receives the set of pages from network 102 in step 240, and in step 242, the user saves the set of communication pages to storage device 127 (not shown in FIG. 2B) connected to client device 106. Client device 106 may be disconnected from server 104 following step 242, if so desired.

Next, in step 244, the user opens at least one page of the set of communication pages saved to storage device 127 on client device 106 in step 242. The page is displayed on client device display 132 (not shown in FIG. 2B) and in step 246, a user generates a request for augmentative communication content using input device 130 on client device 106. Client device 106 processes the request and retrieves the requested content from the set of communication pages saved to storage device 127. Client device 106 processes the augmentative communication content and generates perceptible output on speaker 136, display 132, other means for generating perceptible output on client device 106, or a combination thereof. The user may generate additional augmentative communication output on client device 106 by repeating steps 246 through 248.

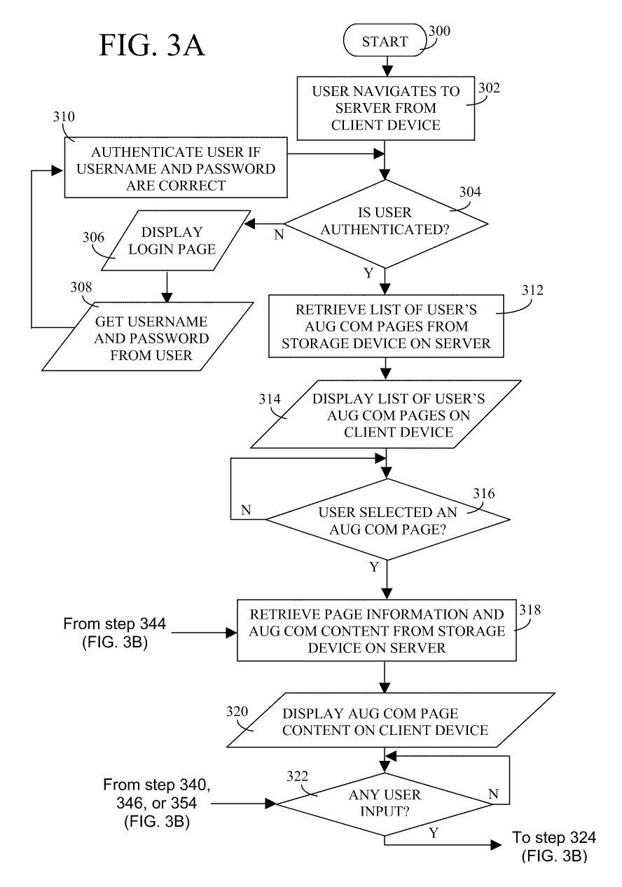

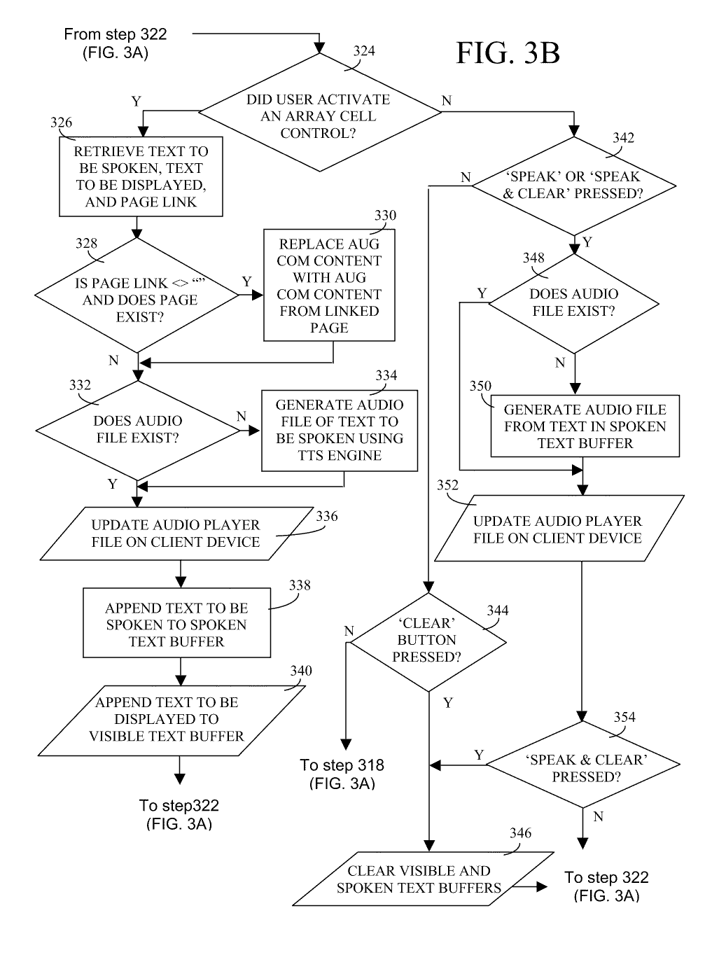

### First Operational Mode—FIG. 3

The flowchart of FIG. 3 illustrates a flowchart of one embodiment of the present invention in operation as an augmentative communication system. The user begins at step 300 by launching a web browser application on the client device. In step 302, the user navigates to the augmentative communication web site running on the server. This may be done, for example, by clicking on an icon in a “Favorites” list or by entering the web site's domain name or IP address into the address bar of the browser on the client device. This sends a page request from the client device to the server via the network.

The server receives the page request from the client device and the web site checks the user's authentication status in step 304. The user must be authenticated before being allowed access to the user's set of augmentative communication pages. If the user has previously logged on from the same client device and still has a valid session cookie, the user is authenticated and immediately taken to step 312. If the user is not authenticated (anonymous), the user is taken to step 306 where the web site sends a login page to the client device.

The unauthenticated user must input a username and password in step 308. The server receives this information in step 310 and the web site authenticates the user if the username and password that the user has submitted match membership records maintained on the storage device connected to the server. The server will only authenticate the user if the username exists, the password is correct, and the user's account has not been locked out.

After the authentication process is performed in step 310, the flow returns to the decision at step 304. If the user successfully authenticated in step 310, the flow branches to step 312. If, instead, the user failed the authentication process in step 310, the server sends the user a message stating that the login attempt was unsuccessful and the user is returned to the login page at step 306. In the first embodiment of the present invention, the number of times the user has failed the authentication process is tracked by a login attempt counter maintained on the server. The maximum number of allowed sequential unsuccessful login attempts is defined in a web site configuration file. If the user fails the login process more than the number of times allotted, the user is locked out and must wait a specific amount of time before the login attempt counter is reset by the system. The login attempt counter is also reset following a successful login.

Users who have been authenticated advance from step 304 to step 312, where a list of the user's augmentative communication pages is retrieved from the storage device on the server. This list may originate from information maintained in one or more database tables, one or more files located in a file system directory, or a combination thereof. In step 314, the server outputs the list of the user's communication pages to the client device display. The system then waits in step 316 until the user selects an augmentative communication page using means for input on the client device.

Once the user has inputted an augmentative communication page selection, the information and content for the selected communication page is retrieved from the storage device on the server in step 318. This information may be retrieved from one or more database tables, one or more files in a file directory, or a combination thereof. The information is comprised of a set of speech properties, a set of page properties, and augmentative communication content.

The set of speech properties may include, but is not limited to, SAPI voice, rate of speech and, optionally, bit rate, sampling frequency, volume, and file format. The set of page properties may include, but is not limited to, a theme, a skin selection, background and foreground colors, font properties, border properties, the dimensions of one or more user control arrays to be displayed on the page, the size of the cells in the one or more arrays, and image dimensions. The augmentative communication content includes text, images, buttons, and active user controls placed in each array cell within the one or more arrays. The augmentative communication content also includes a visible text buffer, a hidden (invisible) spoken text buffer, “Speak”, “Speak & Clear”, and “Clear” button controls, and an augmentative page selector control at the top of the page. Other buttons, as well as standard web site navigation controls which would be obvious to one skilled in the art, may additionally be included around the perimeter of the web page. In an alternate embodiment, an “Undo” button is included as a button control.

In the first embodiment of the present invention, the one or more user control arrays which contain augmentative communication content are comprised of ASP.NET DataLists. Each array cell contains one or more text controls, one or more image controls, or a combination thereof. It is permissible for one or more array cells to be partially or entirely void of augmentative communication content. In various embodiments of the invention, the user control arrays may be constructed using many different types of table representations, such as an ASP.NET GridView, ListView, Repeater, or HTML table. The use of ASP.NET DataLists in the first embodiment is not intended to represent an architectural limitation for the present invention.

Once the web site has gathered the information and content for the selected communication page, the server, in step 320, outputs the page to the client device display. The system then waits in step 322 for user input from the client device. When the user activates a control on the page via input on the client device, an event is fired on the server and the web site branches, at step 324, to server-side code that handles the control that raised the event.

If, in step 322, the user activated an array cell control, the web site retrieves augmentative communication content associated with the activated cell in step 326. This communication content may include, but is not limited to, text to be spoken, text to be displayed, a page link, or a combination thereof. It should be noted that the page link does not actually reference another web page, but rather a subsequent set of one or more user control arrays and an alternate set of augmentative communication content. The term “page link” is used because the updated control collection has the appearance of being a new page from the perspective of the client device.

In the first embodiment of the present invention, the page link specifies the name of a database table that contains the augmentative communication content for a particular communication page. This table includes image information, text, and page links for each of the cells in a single user control array. Each communication page, via the database table and the user control array information within it, may contain a different number of rows and columns than other communication pages and may specify different speech properties and page properties. In the various embodiments of the present invention, the database table for each communication page may include full images, pointers to images located on a storage device connected to the server or a network location, or a combination thereof.

In step 328, the web site checks to see if a page link has been provided for the activated control cell. If a page link has been provided, the web site then verifies that the communication page specified by the page link actually exists. If either the page link is null or the page doesn't exist, the flow branches directly to step 332. If, on the other hand, a page link is provided and the page specified by the page link does exist, the one or more arrays on the page are replaced by the augmentative communication content of the page specified in the page link in step 330. In the first embodiment of the invention, the augmentative communication content is updated via an ASP.NET UpdatePanel, so that only a portion of the page is refreshed on the client device display when the content is changed. Upon completion of step 330, the program advances to step 332.

In step 332, still referring to the augmentative communication content associated with the cell activated in step 324, the web site checks to see if the text to be spoken that was retrieved in step 326 exists in an audio file located on a storage device connected to the server. This audio file contains the text to be spoken using the set of speech properties retrieved in step 318 or step 326. If an audio file with the desired voice, rate of speech, and other speech properties already exists, the web site advances directly to step 336. If it does not exist, such a file is created in step 334.

In the first embodiment of this invention, the audio file is generated in step 334 using an SAPI 5 TTS engine. The audio file is generated in WAV format and saved on a storage device connected to the server. The WAV file is then converted to MP3 format for better compression and immediate playback. Many audio players do not support immediate playback of streaming WAV files, instead waiting for the entire audio data input to be received before beginning playback. Some TTS engines do not support direct output to MP3 format. Although only TTS to WAV audio output is described here, other variations which would be obvious to one skilled in the art are intended to be included within the scope of the present invention. Such variations include TTS to MP3 audio output and TTS to SWF streaming.

Upon completion of step 334, the flow advances to step 336. Still working with the augmentative communication content associated with the cell activated in step 324, the web site, in step 336, updates the audio player parameters on the client device so that the audio player references the filename of the audio file containing audio output of the text to be spoken. In the first embodiment of the invention, this is done with a streaming flash audio player located in an ASP.NET UpdatePanel on the web page. The audio player is set to begin streaming immediately with no loopback.

After updating the audio player parameters in step 336, the program advances to step 338, where the text to be spoken is appended to the spoken text buffer. Next, in step 340, the text to be displayed, also referred to as visible text, is appended to the text in the visible text buffer at the top of the page. The text is handled in this way because it allows the user to display text in a control cell without generating any audio output when the control cell is activated. Additionally, speech engines do not always pronounce words correctly. The dual use of visible and spoken text entries allows the user to display words correctly on the client device display while using an alternate spelling, such as a phonetic spelling, in the text that is submitted to the TTS engine.

Once the web site has finished handling the augmentative communication content associated with the activated cell and the browser on the client device has been updated to receive audio output, visual output, or a combination thereof, the web site returns to step 322 where it awaits further input from the client device.

We now consider the case where, in step 322, the input from the client device is the “Clear” button. The flow branches from step 322 to step 324 to step 342 to step 344, since the user activated a control other than an array cell control and the control is neither “Speak” nor “Speak & Clear”. In step 344, since the “Clear” button was pressed, the flow branches to step 346, where the visible text buffer and spoken text buffer are cleared and the clearing of the visible text buffer also clears the text buffer on the client device display. The system returns to step 322 to wait for further input from the client device.

We now consider the two cases where, in step 322, the user presses the “Speak” button or the “Speak & Clear” button on the client device. In both cases, the flow advances from step 322 to step 324, where the user activated a control other than an array cell control. The flow then branches to step 342 and both the “Speak” and “Speak & Clear” buttons cause the flow to branch to step 348.

In step 348, the server checks to see if an audio file containing audio data of the text to be spoken using the set of speech properties retrieved in step 318 or step 326 exists. If the spoken text buffer is empty or an audio file with the desired voice, rate of speech, and other speech properties already exists, the flow advances to step 352. If, on the other hand, the audio file does not exist, the file is created in step 350. In the first embodiment of this invention, this is done using an SAPI 5 TTS engine. The audio file is generated in WAV format and saved on a storage device connected to the server. The WAV file is then converted to MP3 format for better compression and immediate playback.

Upon completion of step 350, the program advances to step 352. In this step, the web site updates the audio player properties on the client device to specify the filename of the audio file of the text to be spoken. In the first embodiment of the invention, this is done using a streaming flash audio player located in an ASP.NET UpdatePanel on the web page, where the audio player is set to begin streaming immediately.

While similar up to this point, the actions taken for “Speak” and “Speak & Clear” diverge at step 354. If the user pressed the “Speak” button, the web site immediately returns to step 322 and awaits further input. If, on the other hand, the user pressed the “Speak & Clear” button, the flow branches to step 346. Here, the visible text buffer and spoken text buffer are cleared, where the clearing of the visible text buffer also clears the text buffer on the client device display. The flow returns to step 322 and the web site awaits further input from the client device.

Finally, we consider the case where, in step 322, the user wishes to select another augmentative communication page directly without arriving there by activating one or more array cell controls. The user may do this by selecting an alternate communication page from the augmentative page selector control, which may be, for example, a drop-down list or menu. When the user selects a communication page in this manner, the flow branches from step 322 to step 318 through negative decisions at steps 324, 342, and 344.

In step 318, the augmentative communication content for the selected page is retrieved and displayed on the client device while the text in the visible and spoken text buffers is preserved. In this way, the user can navigate between augmentative communication pages that are not directly linked to each other in a reduced number of steps. The user's generated communication continues to be appended to the contents of the text buffer on the client device display.

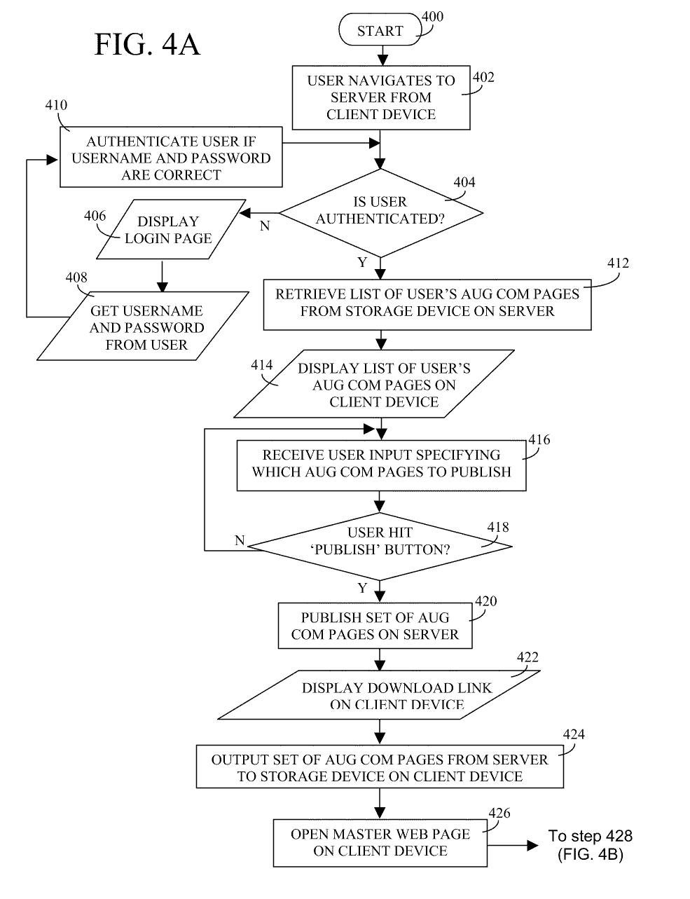

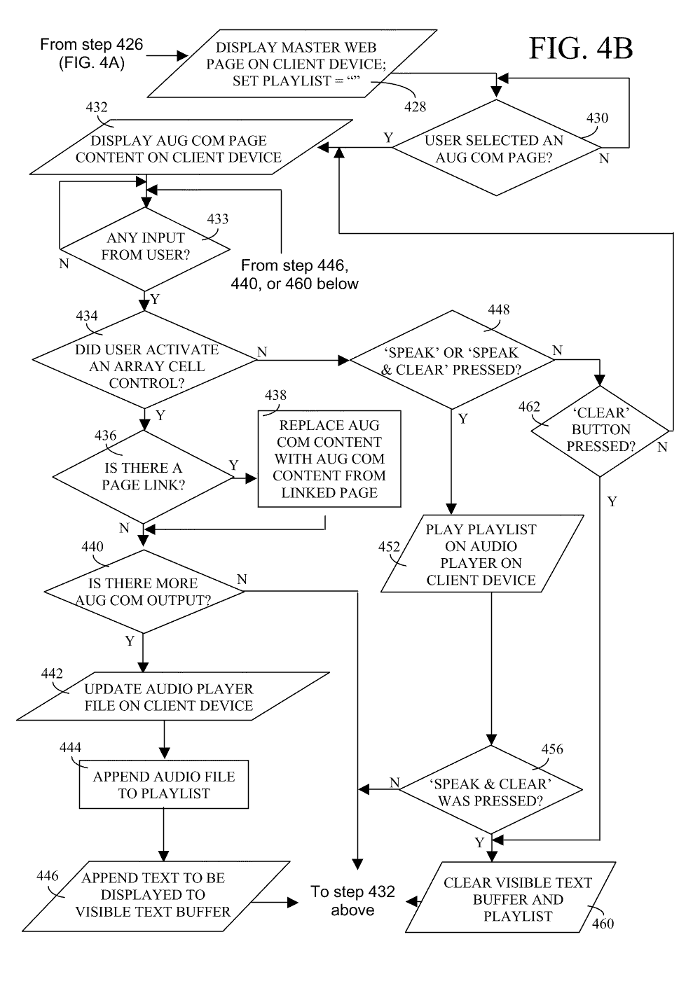

### Second Operational Mode—FIG. 4

In addition to being able to generate augmentative communication by maintaining a network connection to the server, the client device may also request a published set of augmentative communication pages from the server. The published set of communication pages is generated by the server and downloaded to the client device, as flowcharted in FIG. 4. Once the set of pages has been saved to the client device, no further connection between the server and client device is required for the user to generate augmentative communication output.

The user begins at step 400 by launching a browser application on the client device. In step 402, the user navigates to the augmentative communication web site running on the server. The web site checks the user's authentication status in step 404. The user must be authenticated before being allowed access to the user's augmentative communication pages.

If the user has previously logged on from the same client device and still has a valid session cookie, the user is authenticated and immediately taken to step 412. If the user is not authenticated (anonymous), the user is taken to step 406, where the web site sends the client device a login page. The unauthenticated user must input username and password from the client device in step 408. The web site receives this information from the server in step 410 and authenticates the user if the submitted username and password match membership records maintained on the storage device connected to the server. The server will only authenticate the user if the username exists, the password is correct, and the user's account has not been locked out.

After performing the authentication process, the system returns to the decision at step 404. If the user successfully authenticated in step 410, the user advances to step 412. If the user failed the authentication process in step 410, the web site sends the user a message stating that the login attempt was unsuccessful and the user is returned to the login page at step 406. In the first embodiment of the present invention, the number of times the user has failed the authentication process is tracked by a login attempt counter maintained on the server, where the maximum number of allowed sequential unsuccessful login attempts is defined in a web site configuration file. If the user fails the login process more than the allowable number of times, the user is locked out and must wait a specified amount of time before the login attempt counter is reset by the system. The login attempt counter is also reset by a successful login.

Users who have been authenticated advance from step 404 to step 412, where a list of the user's augmentative communication pages is retrieved from the storage device on the server. This list may originate from information maintained in one or more database tables, one or more files located in a file system directory, or a combination thereof. In step 414, the server sends the list of the user's communication pages to the client device where it is displayed. In step 416, the user employs means for input on the client device to select one or more communication pages to include in the published set of pages.

In step 418, the web site checks to see if the user has activated the “Publish” button. If the “Publish” button has not been activated, the web site repeats steps 416 through 418 and continues to accept communication page selection input from the user. When the user presses the “Publish” button in step 418, the web site advances to step 420 and generates a published, stand-alone set of augmentative communication page content. In the first embodiment of the present invention, this augmentative communication page content is comprised of scripted web pages, audio files, images, and an audio player. This content may be assembled from information and content contained in one or more database tables, one or more files in a file system directory, or a combination thereof, located on a storage device connected to the server.

As the web site publishes the augmentative communication content, any missing audio files are generated using a TTS engine with the user's indicated speech preferences. The web site builds a web page for each of the communication pages the user has selected, whereby each web page includes program code to generate audio output, visual output, or a combination thereof, in response to input from the client device. In the first embodiment of the present invention, the set of augmentative communication pages is controlled from a master web page, which incorporates HTML frames and JavaScript. The master web page includes an augmentative communication page selector control, a text buffer, “Speak”, “Speak & Clear”, and “Clear” buttons. In an alternate embodiment of the present invention, the text buffer and buttons may optionally be omitted, depending on which speech mode is selected.

When the web site has finished publishing the set of augmentative communication pages, the web site, in step 422, displays a download link user control on the client device. When this control is activated, the user must, in step 424, select a file directory in which to save the published set of communication pages. The selected file directory may be located on a client device hard drive, a USB flash drive, an FTP site, a local network drive, or other means for storing data connected to the client device. Once the server has outputted the set of pages to the specified file directory, the client device may be disconnected from the server.

In step 426, the downloaded set of augmentative communication pages are located in the file directory and the master web page is opened on the client device. The master page is displayed on the client device display in step 428. Included on the master page are an augmentative communication page selector control, a text buffer, and “Speak”, “Speak & Clear”, and “Clear” buttons. When the master page is opened, a playlist variable is also created. This variable is used to build a playlist of the audio files as they are outputted in response to activation of user controls.

When the user selects a communication page from the augmentative communication page selector control in step 430, the content for the selected communication page is displayed on the client device in step 432. The displayed content is comprised of an array of control cells, whereby each control cell may contain visible text, images, or a combination thereof. Activation of an array control cell may generate audio output, visual output, audio-visual output, or no output on the client device, depending on how the control cell has been configured. For example, one control cell may generate audio output when pressed, while another may load an alternate communication page when pressed. A third may load another communication page and generate audio output on the client device.

After the web page has displayed an augmentative communication page on the client device display in step 432, the web page awaits further user input in step 433. If the user activates an array cell control, the flow diamond continues from step 434 to step 436. If a page link is present, the displayed augmentative communication content will be replaced by the augmentative communication content of the linked communication page in step 438. In the first embodiment of the present invention, this is done by way of an HTML frame load. If no page link was specified, the flow bypasses step 438 and proceeds directly to step 440.

In step 440, the communication page calls any program code responsible for generating additional communication output. This communication output may be in the form of spoken audio output, visible text, or a combination thereof, on the client device. If such program code does not exist, the flow returns to step 433 until further input is received from the user on the client device.

If, in step 440, additional output generating program code exists, steps 442, 444, and 446 are sequentially visited. In step 442, the HTML tag that contains the audio player is updated to begin playback of a specific audio file, where the filename of the specific audio file is provided by the control cell code. This audio file is located within the file directory where the set of augmentative communication pages are saved.

In step 444, the filename of the audio file is appended to the audio player playlist. In the first embodiment of the invention, this playlist is comma-delimited. Finally, in step 446, any text to be displayed as directed by the control cell code is appended to the visible text buffer and the text in the text buffer at the top of the master page is updated. Upon completion of step 446, the flow returns to step 433 until further input is received from the user.

We now consider the case where, in step 433, the input from the client device is the “Clear” button. This takes the flow sequentially through steps 434, 448, 462, and 460, because the user activated a control other than an array cell control, the activated control is neither “Speak” nor “Speak & Clear”, and the “Clear” button was pressed. In step 460, the visible text buffer and playlist are cleared and the clearing of the visible text buffer additionally clears the text buffer on the client device display. The flow returns to step 433 and the web page waits for further input from the client device.

We now consider the two cases where, in step 433, the user presses the “Speak” button or the “Speak & Clear” button on the client device. In both cases, the flow branches through steps 433, 434, 448, and 452 because the user activated a control other than an array cell control and either “Speak” or “Speak & Clear” was pressed. In step 452, the HTML tag that contains the audio player is updated to begin playback of the comma-delimited playlist. The audio files are played consecutively in the order in which they were added to the playlist.

While the actions taken for the “Speak” and “Speak & Clear” buttons are identical up to this point, they diverge at step 456. If the user pressed the “Speak” button, the flow immediately returns to step 433 and the web page awaits further input. If, instead, the user pressed the “Speak & Clear” button, the flow advances to step 460, where the visible text buffer and audio playlist are cleared. The flow then returns to step 433 and awaits further input from the user.

Finally, we consider the case where, in step 433, the user wishes to select another communication page directly, rather than arriving there by activating one or more array cells controls. The user may do this by selecting an alternate communication page from the augmentative communication page selector control. When the user selects a page in this manner, the flow returns to step 432 via steps 433, 434, 448, and 456.

In step 432, the augmentative communication content for the selected communication page is retrieved by way of a frame load, preserving the text in the visible text buffer and the audio playlist. By using the augmentative communication page selector control, the user can navigate between communication pages that are not directly linked to each other in a reduced number of steps. The user's generated communication continues to be appended to the contents of the text buffer on the client device display and the audio playlist.

It should be obvious to one skilled in the art that once a set of communication pages has been published and downloaded from the server to the client device, the set of pages may be accessed indefinitely without having to reconnect the client device to the server. Also, in an alternate embodiment of the present invention, the published set of augmentative communication pages is packed into a single compressed file in step 420. This file, which contains all the content necessary for the communication pages to function, is downloaded by the user in step 424. The contents of this file are extracted to a file directory before the master page is opened in step 426.

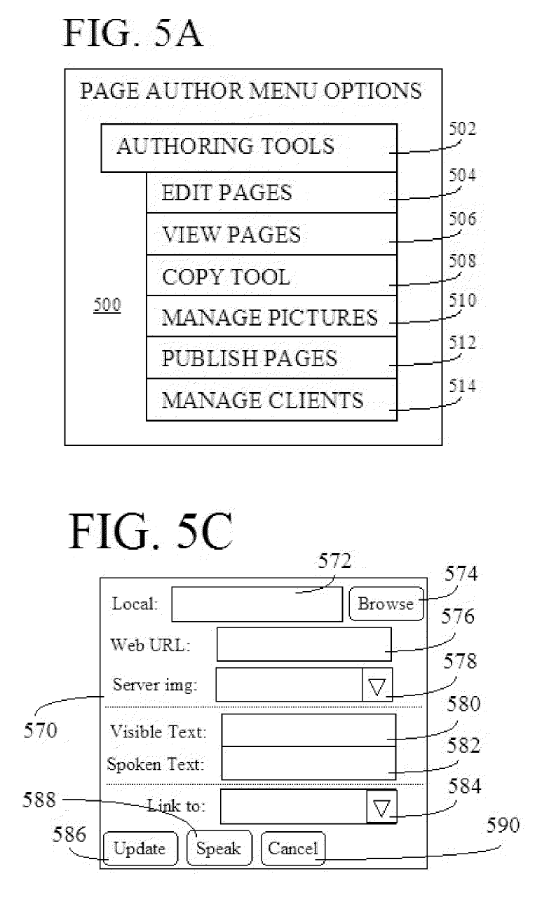

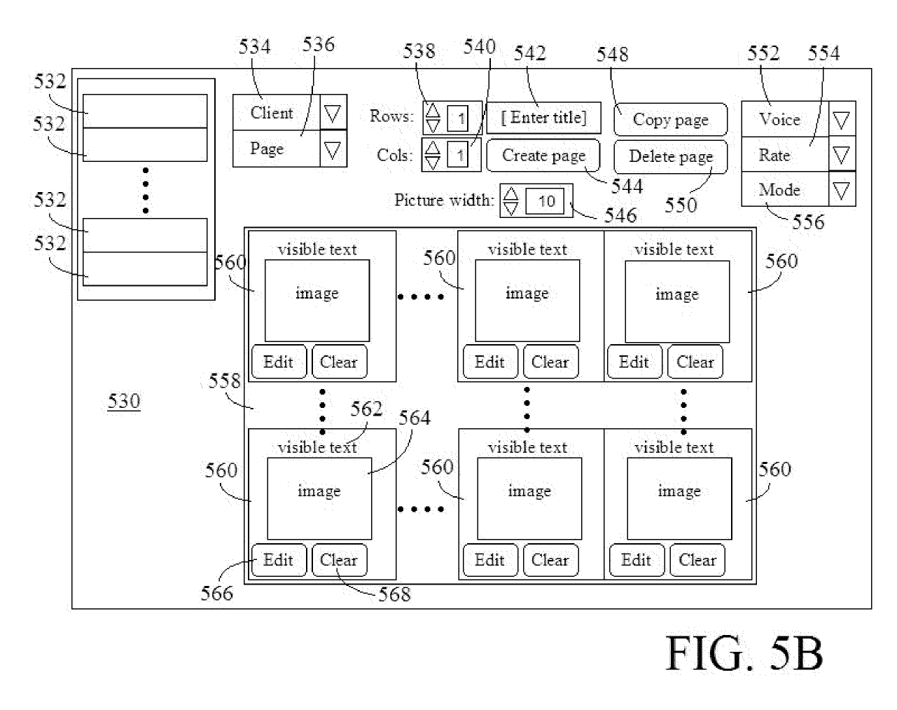

### Editing Mode—FIGS. 5A-5C

The method used to create and edit augmentative communication pages is now discussed, with reference to FIG. 5. In order to create and edit communication pages, the user must be logged in to the server in “edit” mode, also referred to as “page author” mode. This permission structure exists so that communication pages may be accessed in a read-only “user” mode or in a more powerful mode that allows access to additional functions. This role structure also provides parents, speech therapists, and caregivers with a means for managing the communication pages and image collections of one or more user accounts, also referred to as client accounts. Page authors may create a client account for each individual under their care and may specify the page author who will manage each client account. FIG. 5A depicts a block diagram of the menu options available to individuals logged on in page author mode. These options are not available to either anonymous users or authenticated users who have been not been assigned the role of page author.

Page author menu options 500, available only to authenticated page authors, are located under Authoring Tools 502, comprised of the following submenu items: Edit Pages 504, View Pages 506, Copy Tool 508, Manage Pictures 510, Publish Pages 512, and Manage Clients 514.

Among the authoring tools, Edit Pages 504 allows the page author to create, load, edit, copy, and delete augmentative communication pages belonging to any of the page author's client accounts. View Pages 506 allows the page author to test page functionality, especially page linking, for each of the client accounts under the page author's supervision. Copy Tool 508 is used to copy images and communication pages within and between the page author's client accounts and also from a public library located in a shared directory on a storage device connected to the server. Copy Tool 508 is also used to rename and delete communication pages and images in the page author's client accounts.

Manage Pictures 510 is used to import images to a client account from a client device, a web URL, or from the public library, and to add, delete, and rename images within a client account's image collection. In one embodiment of the invention, Manage Pictures 510 includes the ability to generate an image from text so that words may be graphically placed into an image space. As an example, the page author may wish to display “I want” as an image button. This graphic text may include creative and colorful fonts.

Publish Pages 512 allows the page author to create and download a portable, linked set of a client account's augmentative communication pages. Communication pages created using the Publish Pages feature generate visual output, audio output, or a combination thereof, on the client device and require no network connection to the server once they have been downloaded to the client device. Manage Clients 514 allows the page author to manage user names, passwords, and page author assignments for one or more client accounts that the page author has created.

FIG. 5B illustrates the key elements of the Edit Pages web page 530, which is loaded when the Edit Pages 504 option is selected from the submenu of Authoring Tools 502. Menu items 532 provide the page author with hyperlinks to other pages, including, but not limited to, Page Author menu options 500. Client selector control 534 is populated with options when Edit Pages 530 is first loaded to the client device. Client selector control 534 contains only those client accounts that are currently assigned to the authenticated page author.

Once the page author has selected a client account from Client selector control 534, Page selector control 536 is populated with a list of only those pages associated with the client account the page author has selected in Client selector control 534. Rows input 538 and Columns input 540, Title textbox 542, Create Page button 544, and Picture Width input 546 appear, as do Copy Page button 548, Delete Page button 550, Voice selector control 552, Rate of Speech selector control 554, and Speech mode selector control 556. The page author may now edit, copy, or delete an existing communication page by selecting it with Page selector control 536. Upon selection, the selected page will automatically load.

The page author may also create a new communication page for the selected client account. To create a new page, the page author enters a name for the page in Title textbox 542 and also selects the number of rows and columns for the page using Rows input 538 and Columns input 540. When the page author presses Create Page button 544, the server creates a new database table. This table stores the information and content for one or more user control arrays on the newly created page. In order to prevent naming conflicts between different client accounts, the database table is not given the exact name entered in Title textbox 542. In the first embodiment of the present invention, the database table name is a concatenation of an alphabet letter, the user's ID, and the text from Title textbox 542 with any punctuation or spaces removed. In an alternate embodiment of the present invention, the new database table is assigned a unique identifier and the page name and unique identifier are associated in a separate database table.

In the first embodiment of the present invention, the minimum and maximum number of rows and columns a user control array may contain are defined using AJAX NumericUpDownExtender properties. Each communication page contains at least one user control array. This at least one user control array must contain at least one row and one column of control cells and may contain no more than ten rows and ten columns of control cells. One skilled in the art will realize that this example is not intended to represent a limitation on the scope of the present invention.

To make a copy of a page in a client account, the page author selects an existing page using Page selector control 536. The page author enters a name for the copy in Title textbox 542, selects the number of rows and columns for the copy using Rows input 538 and Columns input 540, and then presses Copy Page button 548. This causes the server to create a new database table with the number of entries equal to the number of rows specified in Rows input 538 multiplied by the number of columns specified in Columns input 540. The database table content from the original communication page is copied into the new database using a stored procedure in the database. The row entry corresponding to the cell at row X, column Y in the new table is filled with the data from the cell at row X, column Y in the original database table of the selected page. If the dimensions of the new page are larger than those of the original, some cells are left blank. If the dimensions of the new page are smaller than those of the original, those cells from the original table that do not have a counterpart in the new table will not be present in the new table. In an alternate embodiment, Copy Page 548 is replaced by a collection of user controls that allow the user to insert and remove specific rows and columns from a selected page.

To delete a communication page from a client account, the page author selects an existing page from Page selector control 536, then presses Delete Page button 550. The page author is then prompted by a message box to confirm the deletion of the page. If the page author confirms the deletion, the server removes the database table associated with the selected communication page and removes the reference to the database table from a master list of the client account's communication pages. In the first embodiment of the present invention, any images referenced in the deleted table remain in the client account's image folder on the storage device connected to the server.

In the first embodiment of the present invention, when a page author selects a communication page using the Page selector control 536, content from the database table that represents the page is automatically retrieved from the storage device connected to the server. The number of columns in the page's user control array is determined by calling a stored procedure in the database and an editable user control array 558 with this number of columns is constructed. Editable user control array 558 is populated with user control cells 560, each containing visible text 562, an image button 564, an Edit button 566, and a Clear button 568. In the first embodiment of the present invention, the page author may set the image size, voice, rate of speech, and speech mode for a selected page using, respectively, Picture Width input 546, Voice selector control 552, Rate of Speech selector control 554, and Speech Mode selector control 556. In an alternate embodiment of the invention, speech properties may additionally include such parameters as bit rate, sampling frequency, volume, file format, or a combination thereof.

Picture Width input 546 determines the maximum allowable height and width for each image on the selected communication page. If an image is rectangular, the longer dimension of the image will be set to the Picture Width input value and the shorter dimension will be set to something equal to or less than this value. In other words, the aspect ratios of the images are maintained during resizing. Picture width is independently set for each page so that pages with different user control array dimensionalities may be independently adjusted to properly fill the client device display.

Voice selector control 552 defines which, if any, TTS engine will be used to generate audio output for the text to be spoken. Rate of Speech selector control 554 sets the rate of speech of the TTS engine. Speech Mode selector control 556 determines the way in which the communication page will respond to client-side activation of a user control when the page is in use as a communication page. Depending on which speech mode is enabled, activation of a user control may cause the audio output associated with an activated user control to be spoken immediately, accumulated in a buffer, or a combination thereof.

Upon selecting a communication page from Page selector control 536, the page author is able to view editable user control array 558. A specific user control cell 560 contained in editable user control array 558 may be cleared by pressing the Clear button 568 contained within that specific cell. This removes all image references, text to be displayed, text to be spoken, page links, and other content from the database table entries associated with that specific user control cell. In the first embodiment of the invention, the cell is not deleted from editable user control array 558 but remains as a placeholder.

FIG. 5C illustrates the control cell editor 570, which expands a specific user control cell 560 when the Edit button 566 contained within that cell is pressed. Control cell editor 570 provides several means for specifying image content for the user control cell being edited. In the first embodiment of the invention, an image may be uploaded from a storage device connected to the client device, uploaded directly from a web site URL, or taken from the client account's image collection on the server.

To upload an image from a storage device connected to the client device, the page author either enters an image filename into Local textbox input 572 or selects a filename from a client device file directory using Browse button 574. To upload an image from a web site URL, the page author simply enters the URL for the web site image into Web URL input 576. The image content for the selected user control cell may also be specified using Server image selector control 578, which displays a list of all images in the client account's image collection on the server.

Also contained in control cell editor 570 are Visible Text input 580 and Spoken Text input 582. Visible Text input 580 is used to input any text that will be displayed above the control cell when the page is in use as a communication page. Text entered into Visible Text input 580 will also be appended to the text in the text buffer at the top of the communication page when a user activates the array cell control. The page author similarly uses Spoken Text input 582 to input text to be spoken when the array cell control is activated by a user. In the first embodiment of the invention, the page author may test the TTS audio output for a specific cell by pressing Speak button 588 within control cell editor 570 for that cell. The TTS engine will immediately generate audio output playback on the client device. In this way, the page author can check pronunciation and test modified spellings to produce the correct audio output from the selected TTS engine. The page author may also test the TTS audio output for an unexpanded user control cell 560 by pressing image control 564.

Also contained in control cell editor 570 is Link selector control 584. Link selector control 584 is populated with a list of the client account's communication pages. The page author specifies a communication page in Link selector control 584 if the server is to replace the content of the current communication page with content of the linked communication page when the given user control is pressed. If Link selector control 584 is null or if a communication page specified in Link selector control 584 does not exist, the current communication page will not be replaced by an alternate communication page. To state this another way, the user control array associated with the current communication page will be replaced by the user control array associated with the linked communication page when the given user control is activated.

When the page author wishes to update a control cell, the page author presses Update button 586 within control cell editor 570. This updates the database table entries associated with the given cell. The text contained in Visible text input 580 and Spoken text input 582 are stored and the server determines if any image content is to be uploaded to the server from a directory on the client device or from a web URL. If image content is to be uploaded, the server verifies that the image filename extension is JPG, GIF, BMP, or PNG and that the image does not exceed a specified height, width, or file size. If these criteria are satisfied, the image is uploaded to the client account's image collection and the image information for the selected cell is updated in the database table. The database table is also updated in the case where an image has been specified from the client account's image collection using Server image selector control 578.

In the first embodiment of the present invention, the contents of any number of cell control inputs may be left blank during a control cell update. This allows the user to include visible text with no spoken text, so as to produce no audio output upon control activation. In another example, the user may want to display an image with no visible text, but with spoken audio output. Although only two combinations are mentioned in this example, other variations that would be obvious to one skilled in the art are intended to be included within the scope of the present invention.

If, at any time during control cell editing, the page author wishes to leave the control cell editor without updating and cancel all changes, the page author may press Cancel button 590 in control cell editor 570. The database table and user control cell will be left in the state they were prior to Edit button 566 being pressed. In the first embodiment of the present invention, the page author may only edit one user control cell at a time and a given control cell will only be updated when Update button 586 is pressed within that cell.

### CONCLUSION, RAMIFICATIONS, AND SCOPE

Accordingly, the augmentative communication method and system of the present invention provides an economical, highly adaptable method and system of augmentative communication that can be used by persons with a wide range of verbal communication skills levels across multiple devices. The invention being thus described, it will be obvious that the same may be varied in many ways. Such variations are not to be regarded as a departure from the spirit and scope of the invention, and all such modifications as would be obvious to one skilled in the art are intended to be included within the scope of the descriptions.

For example, one feature not explicitly described in the drawings is the option where the user may, from the client device, manually type or paste text directly into the text buffer at the top of the communication page. This feature, when enabled, utilizes a string comparator and an additional (hidden) text buffer to insert the text the user has entered into the text buffer into the text already present in the visible and spoken text buffers. Thus, the user can input supplemental text into the text buffer when it isn't readily available in an array control cell or may be more easily entered from an alternate source.

An alternate embodiment of the present invention additionally allows the user to send text directly from the text buffer to an email address using a mail server. This feature allows the user to document something that the user has communicated by providing a dated, time-stamped record of the communication to one or more email accounts specified by the user. The user may, in another embodiment, send the content of the text buffer in the form of a text message.

Also not explicitly shown in the drawings but included in an embodiment of the present invention is the ability for a user to add images to the user's image collection by sending them directly to the server via an email with an image attachment from a client device. This method is particularly suited for mobile devices but works equally well with any device capable of sending emails with image attachments.

In an alternate embodiment of the present invention, the page author, in editing mode, has access to one or more additional control cell inputs which provide additional means for providing audio content. The page author may enter audio files into these one or more control cell inputs, thus providing audio content directly to a client account's audio file collection. This audio content may be used instead of audio files that would otherwise be generated by one or more TTS engines. Additional means for providing audio content may include, for example, an input for uploading pre-recorded audio files to the server from a client device, an input for uploading pre-recorded audio files to the server from a network location, an input for recording audio files directly to the server from an audio input apparatus on the client device, or a combination thereof. In this way, a user's parent, caregiver, or therapist may record augmentative communication. This communication allows the user to generate more realistic audio output in any language.

Also not explicitly differentiated in the drawings are several speech modes, including, for example, “Speak All” and “Speak Each”. These speech modes differ in the way they respond to client-side activation of a user control. Depending on which speech mode is enabled, activation of a user control may cause the audio output associated with an activated user control to be spoken immediately, accumulated in a buffer, or a combination thereof. Although only two speech modes are mentioned in this example, other variations that would be obvious to one skilled in the art are intended to be included within the scope of the present invention.

Accordingly, the scope of the invention should be determined not by the embodiments illustrated, but by the appended claims and their legal equivalents.

What is claimed is:

1. A network-based method for providing augmentative communication comprising the steps of:
(a) receiving a request for augmentative communication content from a client device, wherein the request is directed to a server, wherein said server has a server-side storage device, and wherein said client device and said server are connected via a network;
(b) retrieving said augmentative communication content from said server-side storage device; and
(c) outputting said augmentative communication content to means for generating perceptible output on said client device.

2. The method of claim 1, wherein said means for generating perceptible output comprises means for generating audibly perceptible output, means for generating visually perceptible output, or a combination thereof.

3. The method of claim 1, wherein said server is a web server and wherein said request for said augmentative communication content is made from a web browser on said client device.

4. The method of claim 1, wherein said augmentative communication content comprises text, images, audio files, one or more arrays of user controls, computer readable program code means for generating requests for augmentative communication content, or a combination thereof.

5. The method of claim 1, further comprising, after said step (a),
generating at least a portion of said augmentative communication content on said server;
saving the at least a portion of said augmentative communication content to said server-side storage device; and, thereafter,
performing said steps (b) and (c).

6. The method of claim 5, wherein generating at least a portion of said augmentative communication content on said server comprises generating audio files using a text-to-speech engine, and wherein said text-to-speech engine is located on said server.

7. The method of claim 6, further comprising storing at least a portion of the outputted augmentative communication content in a memory on said server for subsequent use in generation of augmentative communication output.

8. A network-based method for providing augmentative communication comprising the steps of:
(a) receiving a request for a set of augmentative communication pages from a client device, wherein the request is directed to a server, wherein said server has a server-side storage device, and wherein said client device and said server are connected via a network,
wherein said set of augmentative communication pages comprises a plurality of files including user page files, images, audio files, or a combination thereof, and
wherein said user page files comprise computer readable program code means for:
displaying text;
displaying images;
displaying one or more arrays of user controls;
generating requests for augmentative communication content;
or a combination thereof;
(b) generating at least a portion of said set of augmentative communication pages on said server;
(c) saving the at least a portion of said set of augmentative communication pages to said server-side storage device;
(d) retrieving said set of augmentative communication pages from said server-side storage device;
(e) outputting said set of augmentative communication pages to a client-side storage device;
(f) opening one of said set of augmentative communication pages on said client device,
wherein said one of said set of augmentative communication pages is opened from said client-side storage device, and
wherein said one of said set of pages contains at least one computer readable program code means for generating a request for augmentative communication content;
(g) generating a request for augmentative communication content from said at least one computer readable program code means for generating a request for augmentative communication content contained on said one of said set of augmentative communication pages; and
(h) outputting said augmentative communication content to means for generating perceptible output on said client device.

9. The method of claim 8, wherein said server is a web server and wherein said request for said set of augmentative communication pages is made from a web browser on said client device.

10. The method of claim 8, wherein said set of augmentative communication pages further comprises a streaming audio player, said streaming audio player has a playlist, and wherein at least a portion of the outputted augmentative communication content is stored in said playlist in a memory on said client device for subsequent use in generation of augmentative communication output.

11. A network-based system for providing augmentative communication comprising:
(a) means for receiving a request for augmentative communication content from a client device, wherein the request is directed to a server, wherein said server has a server-side storage device, and wherein said client device and said server are connected via a network;
(b) means for retrieving said augmentative communication content from said server-side storage device; and
(c) means for outputting said augmentative communication content to means for generating perceptible output on said client device.

12. The system of claim 11, wherein said means for generating perceptible output comprises means for generating audibly perceptible output, means for generating visually perceptible output, or a combination thereof.

13. The system of claim 11, wherein said server is a web server and wherein said request for said augmentative communication content is made from a web browser on said client device.

14. The system of claim 11, wherein said augmentative communication content comprises text, images, audio files, one or more arrays of user controls, a set of augmentative communication pages, computer readable program code means for generating requests for augmentative communication content, or a combination thereof,
wherein said set of augmentative communication pages comprises a plurality of files including user page files, and
wherein said user page files comprise computer readable program code means for:
displaying text;
displaying images;
displaying one or more arrays of user controls;
generating requests for augmentative communication content;
or a combination thereof.

15. The system of claim 14, further comprising means for uploading said images to said server, wherein said means for uploading images includes:
means for uploading images from a storage device connected to said client device;
means for uploading images from a network location, wherein said network location is connected to said client device and said server via a network connection;
means for uploading images via a mail server, wherein said server receives emails, and wherein said emails include said images as attachments;
or a combination thereof.

16. The system of claim 11, further comprising:
(d) means for generating at least a portion of said augmentative communication content on said server; and
(e) means for saving the at least a portion of said augmentative communication content to said server-side storage device.

17. The system of claim 16, wherein said means for generating at least a portion of said augmentative communication content on said server comprises a text-to-speech engine, wherein said text-to-speech engine is located on said server.

18. The system of claim 17, further comprising means for storing at least a portion of said outputted augmentative communication content in a memory on said server for subsequent use in generation of augmentative communication output.

19. The system of claim 14, further comprising:
(d) means for generating at least a portion of said augmentative communication content on said server;
(e) means for saving the at least a portion of said augmentative communication content to said server-side storage device;
(f) means for retrieving said set of augmentative communication pages from said server-side storage device;
(g) means for outputting said set of augmentative communication pages to a storage device connected to said client device;
(h) means for opening one of said set of augmentative communication pages from said client device, wherein said one of said set of augmentative communication pages is opened from said storage device connected to said client device, and wherein said one of said set of pages contains at least one computer readable program code means for generating requests for augmentative communication content; and
(i) means for generating a request for augmentative communication content from said at least one computer readable program code means for generating requests for augmentative communication content contained on said one of said set of augmentative communication pages.

20. The system of claim 19, wherein said server is a web server, wherein said request for said set of augmentative communication pages is made from a web browser on said client device, and wherein said user page files are comprised of web pages.
